(19) United States
(12) Patent Application Publication
(10) Pub. No.: US 2018/0126395 A1
(43) Pub. Date: May 10, 2018

(54) Fluid Distributor Body and Sanitary Shower Device

(71) Applicant: Hansgrohe SE, Schiltach (DE)

(72) Inventor: Arthur Klassen, Fluorn-Winzeln (DE)

(73) Assignee: Hansgrohe SE, Schiltach (DE)

(21) Appl. No.: 15/794,658

(22) Filed: Oct. 26, 2017

(30) Foreign Application Priority Data
Nov. 4, 2016 (DE) 102016221650.3

(51) Int. Cl. B05B 1/30; E03C 1/086; E03C 1/084

(52) U.S. Cl. CPC B05B 1/3006; E03C 2201/60; E03C 1/084; E03C 1/086

(57) ABSTRACT

A fluid distributor body and an associated sanitary shower device containing the fluid distributor body have a cylindrical boundary forming a fluid inlet on an axial input side, and a distributor structure disposed downstream of the fluid inlet for fluid distributing flow conductance of a fluid supplied via the fluid inlet. The distributor structure is provided by at least one perforated distributor plate held on the boundary and having a plurality of passage openings conically tapering in the flow direction. The fluid distributor body and sanitary shower device are useful for sanitary overhead showers, for example.

The invention relates to a fluid distributor body, and to a sanitary shower device which is able to be equipped with a fluid distributor body and which has a shower inlet region with a shower inlet, has a shower outlet and has a waterway, i.e. water conduit, from the shower inlet to the shower outlet.

It is known, for example in water-conducting sanitary installations, such as shower devices and fittings arranged upstream thereof and also bathtub and washstand fittings, that perceptible flow noises can occur when water flows through said installations during operation. The water flow noise can arise in a particularly loud and thus possibly disruptive manner in particular in regions in which the water conducted through is diverted relatively intensely, for example from an axial main flow direction into a transverse main flow direction, perpendicular thereto, within a shower head or the like, or because of a correspondingly large curvature of a water-conducting line.

It is known to use throughflow regulator or jet regulator components, which typically contain one or more perforated-plate, grate or mesh structures composed of a dimensionally stable metal or plastic material, at the outflow end of sanitary outflow fittings, see for example the utility model specification DE 93 14 990 U1. In the case of a jet regulator of said type disclosed in the laid-open specification DE 102 46 334 A1, an outlet-side housing part composed of elastomer material is additionally provided in order to facilitate the detachment of limescale deposits. In the case of a further jet regulator of said type disclosed in the utility model specification DE 20 2011 105 376 U1, a plate-like functional part composed of elastic material with throughflow holes which are able to change shape in a water-pressure-dependent manner is held on a dimensionally stable support part in order for it to be possible to adjust the water throughflow to a fixable maximum rate. Said jet regulators are neither intended nor suitable for reducing flow noises in sanitary fittings.

It is an object of the invention to provide a fluid distributor body which is suitable for reducing such flow noises, and a sanitary shower device equipped therewith.

The invention solves this and other objects by providing a fluid distributor body which comprises a cylindrical boundary, forming a fluid inlet on an axial input side, and a distributor structure disposed downstream of the fluid inlet for fluid distributing flow guidance of a fluid supplied via the fluid inlet, wherein the distributor structure is provided by at least one perforated distributor plate made of an elastomer material and held on the boundary and having a plurality of passage openings conically tapering in flow direction. The invention achieves this and other objects also by providing a sanitary shower device which comprises a shower inlet region comprising a shower inlet, a shower outlet region comprising a shower outlet, a waterway from the shower inlet to the shower outlet, and a fluid distributor body disposed in the waterway, wherein the fluid distributor body comprises a cylindrical boundary, forming a fluid inlet on an axial input side, and a distributor structure disposed downstream of the fluid inlet for fluid distributing flow guidance of a fluid supplied via the fluid inlet, wherein the distributor structure is provided by at least one perforated distributor plate made of an elastomer material and held on the boundary and having a plurality of passage openings conically tapering in flow direction.

The fluid distributor body according to the invention contains a cylindrical boundary which forms a fluid inlet on an axial input side, and contains a distributor structure which is arranged downstream of the fluid inlet and which serves for the fluid-distributing flow guidance of a fluid supplied via the fluid inlet. The distributor structure is formed by at least one perforated distributor plate which is held on the boundary and which is composed of an elastomer material and which has a plurality of passage openings tapering conically in the flow direction. It has been found that the distributor plate realized in this manner has very good noise-reducing properties. The passage openings preferably form pure perforations of the distributor plate, that is to say they preferably extend within the plate thickness without projecting therebeyond. Using said fluid distributor body allows flow-induced noise development to be counteracted at the place of use of the fluid distributor body. As a result, it is possible to avoid undesirably high flow noise levels, in particular also at relatively high fluid pressure. The conically tapering form of the passage openings can also offer technical advantages in terms of production, for example it can allow production of the distributor structure or the distributor body as a plastic injection-molded part with relatively little effort overall. The fluid distributor body is suitable for example for use as a sanitary fluid distributor body in the inflow region of a sanitary fitting, in particular in a region of a relatively intense or abrupt diversion of a water conduit or water flow situated there.

In one refinement of the invention, the fluid distributor body is formed as a one-piece component, this offering, inter alia, technical advantages in terms of production. The distributor structure is in this case formed in one piece with the cylindrical boundary and therefore does not need to be produced as a separate component and attached to the cylindrical boundary.

In one refinement of the invention, the boundary consists of an elastomer material. A boundary consisting of an elastomer material may be used as a seal if required, that is to say the fluid distributor body may in this case perform a dual function as a sealing element and as a noise-damping element. Advantageously, it is possible for the fluid distributor body to be produced overall as a one-piece component composed of elastomer material.

In one refinement of the invention, at least part, i.e. some, of the passage openings have opening longitudinal axes which diverge in the flow direction. This measure allows a diversion of the flow from a direction with an axial main component into a direction with a transverse main component, perpendicular thereto, to be promoted, that is to say a diversion of a flow which has a main direction component which is parallel to an axial direction of the fluid distributor body into a flow which has a main direction component which is perpendicular to said axial direction.

In one refinement of the invention, the distributor plate has a shape which is curved outwardly toward the center of the plate in the flow direction. This, too, promotes a flow diversion from a predominantly axial direction into a predominantly transverse direction if required. Moreover, this can result in functional advantages and technical advantages in terms of production.

In one refinement of the invention, the passage openings are arranged so as to be distributed over multiple radii of the distributor plate. This arrangement of the passage openings can likewise have an advantageous influence on the noise-reducing function of the fluid distributor body and offer technical advantages in terms of production.

In one refinement of the invention, at least some of the passage openings have a trapezoidal, i.e. trapeziform, cross section, and the associated passage openings are separated from one another by separating strips, wherein the separating strips have a cross section which enlarges in a triangular manner in the flow direction. This realization of the distributor structure promotes the noise-reducing effect of the distributor body and offers technical advantages in terms of production. For example, the distributor plate or the fluid distributor body may be produced by way of a plastic injection-molding technique from elastomer material or from another plastic material with relatively little effort overall.

Alternatively, other cross sections are also possible for the passage openings and suitable for the desired function of the noise reduction, for example a circular or oval or a honeycomb-shaped, hexagonal cross section, wherein the separating strips can likewise have a cross section which enlarges in a triangular manner in the flow direction or alternatively can have another cross section. It has been found that the fluid distributor body in question allows a particularly good reduction of flow noises specifically for an embodiment having a regular pattern of such passage openings with a hexagonal cross section.

In one refinement of the invention, a minimum output cross section of the passage openings is smaller than a thickness of the distributor plate and thus also smaller than a throughflow length, corresponding to said thickness, of the passage openings. It has been found that this measure can contribute to a large extent to the desired, noise-reducing effect of the distributor structure and thus of the distributor body overall.

In the sanitary shower device according to the invention, the fluid distributor body according to the invention is arranged in the water conduit from the shower inlet to the shower outlet. This allows the noise development of the sanitary shower device to be reduced, and the fluid distributor body can also perform a sealing function in the sanitary shower device if required.

In one refinement of the invention, the fluid distributor body is arranged in a shower connector body adjoining a shower main body or in the shower main body adjoining the shower connector body or between the shower connector body and the shower main body, wherein the shower connector body contains the shower inlet region and the shower main body, which is connected to the shower connector body and which contains the shower outlet region with the shower outlet via which an associated shower jet is released, follows the shower connector body in the flow direction. For example, the shower main body may be a shower head body of an overhead shower device of flat construction, which body is coupled in a pivotably movable manner, for example via a ball joint, to the shower connector body of, for example, tube connector form. In this case, the fluid distributor body can promote a desired diversion of the axially inflowing water into the transverse direction, perpendicular thereto, and at the same time counteract noise development which arises as a result. The fluid distributor body can at the same time function as a sealing element between the shower main body and the shower connector body if required.

In one refinement of the invention, a flow restrictor is arranged upstream before the distributor body. Said restrictor can provide additional noise reduction and/or throughflow reduction. Advantageously, it may be a flow restrictor as disclosed and described in the German patent application 10 2016 218 917.4 of the applicant, the entire content of which in this respect is hereby incorporated into the present application by reference.

Advantageous embodiments of the invention are illustrated in the drawings and are described below. In the drawings:

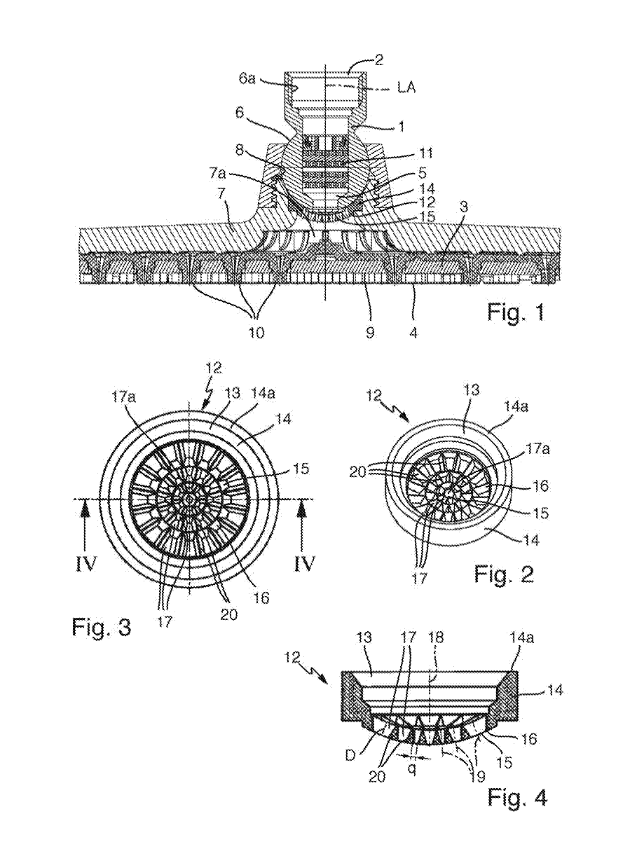

FIG. 1 shows a longitudinal sectional view of one part of a sanitary shower device,

FIG. 2 shows a perspective view of a fluid distributor body, used in the sanitary shower device in FIG. 1, with an outwardly curved distributor plate having passage openings which are trapeziform in cross section,

FIG. 3 shows a plan view of the fluid distributor body in FIG. 2,

FIG. 4 shows a longitudinal sectional view along a line IV-IV in FIG. 3,

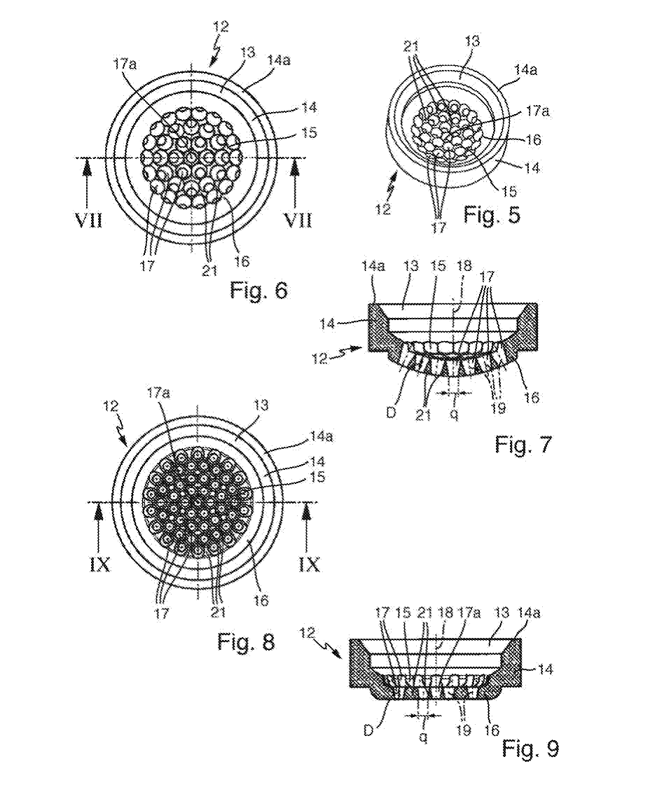

FIG. 5 shows a view corresponding to FIG. 2 for an embodiment variant of the fluid distributor body having passage openings which are circular in cross section,

FIG. 6 shows a plan view of the fluid distributor body in FIG. 5,

FIG. 7 shows a longitudinal sectional view along a line VII-VII in FIG. 6,

FIG. 8 shows a view corresponding to FIG. 6 for an embodiment variant of the fluid distributor body with a flat distributor plate, and

FIG. 9 shows a longitudinal sectional view along a line IX-IX in FIG. 8.

The sanitary shower device in FIG. 1 comprises a shower inlet region 1 with a shower inlet 2, and comprises a shower outlet region 3 with a shower outlet 4. A water conduit 5 leads from the shower inlet 2 to the shower outlet 4. The sanitary shower device shown by way of example may be used for example as an overhead shower device of flat construction of a shower system.

In the exemplary embodiment shown, the shower inlet region 1 is formed by a shower connector body 6 to which a shower main body 7 which comprises the shower outlet region 3 is connected. In the example shown, the connection is realized by a ball joint 8, whereby the shower main body 7 is held on all sides in a pivotably movable manner on the shower connector body 6, the latter being in this case of tube connector form and being able to be coupled for its part to a conventional water supply connection (not shown) via a connecting thread 6a. The shower outlet region 3 may be formed for example by a conventional one-piece or, as shown, multi-piece jet disc 9 having a plurality of jet output openings 10 which provide a corresponding shower jet of the shower outlet 4.

A fluid distributor body 12 is arranged in the water conduit 5 and, in the example shown, specifically in the connecting region of the shower connector body 6 and the shower main body 7, depending on the configuration in the shower main body 7 adjoining the shower connector body 6 or in the shower connector body 6 adjoining the shower main body 7 or between the two bodies. Optionally, a flow restrictor 11 may be arranged upstream of the fluid distributor body 12, as shown. In the case shown, the flow restrictor 11 is arranged upstream of the fluid distributor body 12 and adjoining the latter in the shower connector body 6. The optional flow restrictor 11 may in particular be one as disclosed and described in detail in the abovementioned patent application DE 10 2016 218 917.4 of the applicant, to which reference can be made here for further details.

In FIGS. 2 to 4, the fluid distributor body 12 is illustrated in more detail and separately in an advantageous realization as used in the shower device shown in FIG. 1. In general, the fluid distributor body 12 contains a cylindrical boundary 14 which forms a fluid inlet 13 on an axial input side 14a, and contains a distributor structure 15 which is arranged downstream of the fluid inlet 13 and which serves for the fluid-distributing flow guidance of a fluid supplied via the fluid inlet 13. The distributor structure 15 is formed by at least one perforated distributor plate 16 which is held on the boundary 14 and which has a plurality of passage openings 17 tapering conically in the flow direction.

In the example shown, the fluid distributor body 12 is formed as a one-piece component, advantageously made of an elastomer material. Said component may be produced for example in a plastic injection-molding technique, alternatively by another conventional production method including a 3D printing technique. In alternative configurations, the fluid distributor body 12 is of multi-piece form, for example in that the distributor plate 15 is produced as a component which is separate from the boundary 14 and is attached to the boundary 14 by a conventional connecting technique, wherein in this case, the distributor plate 15 and the boundary 14 may consist of an identical material, such as an elastomer material, or different materials, for example only the distributor plate 15 or only the boundary 14 consisting of an elastomer material and the other component consisting of a material which differs therefrom.

In the realization shown in FIGS. 2 to 4, the distributor plate 15 has a shape which is curved outwardly toward the center of the plate in the flow direction. In this case, the flow direction is from the axial input side 14a to the opposite, axial face side of the fluid distributor body 12 in its axial direction, which is defined by the longitudinal central axis 18 of said body. In the example shown, the distributor plate 15 is situated on said opposite face side.

In the realization according to FIGS. 2 to 4, the passage openings 17 are arranged so as to be distributed over multiple radii of the distributor plate 15 with the exception of a central outlet opening 17a. Specifically, the passage openings 17 in the example shown are arranged so as to be distributed all the way around the central passage opening 17a over three radii.

At least some and preferably all of the passage openings 17 have opening longitudinal axes 19 which diverge in the flow direction, that is to say the latter extend at a predefined divergence angle in an inclined manner with respect to the axial direction, or to the longitudinal central axis 18, with a component which points radially outwardly in the flow direction. This contributes, together with the conical tapering of the passage openings 17 and the outwardly curved shape of the distributor plate 16, to the desired flow-distributing function of the fluid distributor body 12, by way of which function axially inflowing fluid is able to be distributed, or guided further such that it is diverted, so as to have a radially outwardly pointing, transverse flow component.

Furthermore, it can be seen from FIGS. 2 to 4 that at least some and preferably all of the passage openings 17 have a trapeziform cross section in this realization, with the exception of the central passage opening 17a, which has a circular cross section. For this purpose, the passage openings 17 are separated from one another by separating strips 20 which have a cross section which enlarges in a triangular manner in the flow direction.

As can be seen in particular from FIG. 4, the distributor structure 15 in the example shown is formed such that a minimum output cross section q of the passage openings 17 is smaller than a thickness D of the distributor plate 16. This promotes desired, targeted conducting of flow by way of the desired fluid-distributing function.

As can be seen from FIG. 1, in the case of the use of the fluid distributor body 12 shown there, the cylindrical boundary 14 can at the same time function as a sealing element which ensures a necessary sealing of the water conduit 5 with respect to the ball joint 8 or to the connecting region of the shower connector body 6 and the shower main body 7. For this purpose, the boundary 14 is then produced from a suitable sealing material, for example an elastomer material, as mentioned. At the same time, the distributor structure 15 promotes, at said place of use of the fluid distributor body 12, the required distribution and diversion of the fluid supplied via the shower inlet 2 axially or parallel to a longitudinal central axis LA of the shower device into a transverse, radially outwardly directed distributed flow, substantially perpendicular thereto, by way of which the fluid passes to all jet output openings 10 of the shower device in a largely uniform manner in order to supply said openings with fluid. As a result of the flow-guiding and flow-distributing function of the fluid distributor body 12, direct axial impingement of the supplied fluid onto an inner flow-conducting contour 7a, opposite the fluid inlet, of the shower main body 7 and associated noise development are in this case avoided. When the optional noise restrictor 11 is additionally used, it can additionally contribute to the noise reduction and flow restriction.

FIGS. 6 to 9 illustrate two further realization variants for the fluid distributor body 12, wherein, for the sake of easier understanding, identical or functionally equivalent elements are provided with the same reference signs and, in this respect, reference can also be made to the above descriptions relating to the realization according to FIGS. 2 to 4. Unless specified to the contrary in the following, the effects and advantages stated above relating to the embodiment in FIGS. 2 to 4 apply in an analogous manner to the embodiments according to FIGS. 6 to 9.

In the embodiment according to FIGS. 5 to 7, the passage openings 17 are formed with a circular instead of a trapeziform cross section. Otherwise, this exemplary embodiment corresponds to the exemplary embodiment in FIGS. 2 to 4, and so, for all further features, properties and advantages, reference can be made to the above explanations of the latter embodiment.

Opening edge regions or opening intermediate-space sections 21, which give the distributor structure 15 a honeycomb-like contour in this case, remain between the passage openings 17, which are circular in cross section, wherein the opening edge regions 21 are contiguous with one another just like the separating strips 20 in the exemplary embodiment in FIGS. 2 to 4, that is to say the distributor structure 15 forms in both cases a contiguous structure in which the passage openings 17 are formed separately from one another. Like the separating strips 20, the opening edge regions 21 also have a triangular cross section which enlarges in the flow direction corresponding to the profile of the passage openings 17, said profile being conically tapering in the flow direction.

The embodiment illustrated in FIGS. 8 and 9 differs from the embodiment in FIGS. 5 to 7 essentially only in that the distributor plate 16 is formed as a flat plate in this case and the passage openings 17 are formed here with opening longitudinal axes 19 in the distributor plate 16 which are parallel to one another and to the longitudinal central axis 18 of the fluid distributor body 12. Moreover, the passage openings 17 are arranged all the way around the central passage opening 17a over four radii of the distributor plate 16. Here too, all the passage openings 17 taper conically in the flow direction and can contribute in this way to fluid-distributing flow guidance and flow restriction with corresponding noise reduction, in particular if the minimum output cross section q of the passage openings 17 is smaller than the thickness D of the distributor plate 16, again as shown, and the distributor structure 15 or the distributor plate 16 consists of an elastomer material.

In further embodiments (not shown) of the invention, the distributor plate does not have a flat or outwardly curved form but another form, for example inwardly curved, and/or the passage openings do not have a trapeziform or circular cross section but another cross section, for example an oval or polygonal, for example hexagonal, cross section. Specifically, such an alternative embodiment of the invention corresponds to the embodiment in FIGS. 8 and 9 with the difference that the passage openings have a hexagonal instead of circular cross section. This embodiment can be very advantageous technically in terms of production, and with regard to flow noise reduction.

As made clear by the exemplary embodiments shown and explained above, the invention provides a fluid distributor body which may be produced in a relatively simple manner if required and with which fluid-distributing flow guidance can be achieved such that flow noises which otherwise occur can be avoided or in any case reduced. In further embodiments (not shown) of the invention, sanitary shower devices other than that shown in FIG. 1, which may be for example different overhead shower devices or hand-held shower devices or side shower devices, are equipped with the fluid distributor body according to the invention, preferably in the shower inlet region of the sanitary shower device, as described, but alternatively also at another position. In further alternative embodiments of the invention, the fluid distributor body according to the invention is used, in one of the shown variants or in another embodiment variant, in another sanitary installation instead of in a sanitary shower device, for example in mixer fittings and other water-conducting fittings and tubing sections of bathtub and washstand systems or shower systems. Not least, the use of the fluid distributor body according to the invention in non-sanitary, fluid-conducting systems is also possible.

1. A fluid distributor body comprising:
a cylindrical boundary, forming a fluid inlet on an axial input side of the fluid distributor body, and
a distributor structure disposed downstream of the fluid inlet structured for fluid distributing flow guidance of a fluid supplied via the fluid inlet,
wherein the distributor structure is provided by at least one perforated distributor plate made of an elastomer material and held on the boundary and having a plurality of passage openings conically tapering in flow direction.

2. The fluid distributor body according to claim 1, wherein the fluid distributor body is a one-piece component.

3. The fluid distributor body according to claim 1, wherein the boundary is composed of an elastomer material.

4. The fluid distributor body according to claim 1, wherein at least part of the passage openings have opening longitudinal axes diverging in flow direction.

5. The fluid distributor body according to claim 1, wherein the passage openings are arranged and distributed over a plurality of radii of the distributor plate.

6. The fluid distributor body according to claim 1, wherein at least part of the passage openings have a trapezoidal cross section and corresponding said passage openings are separated from each other by separating strips which have a cross section enlarging in flow direction in a triangular shape.

7. The fluid distributor body according to claim 1, wherein a minimum output cross section of the passage openings is smaller than a thickness of the distributor plate.

8. A sanitary shower device, comprising:
a shower inlet region comprising a shower inlet,
a shower outlet region comprising a shower outlet,
a waterway from the shower inlet to the shower outlet, and
a fluid distributor body disposed in the waterway,
wherein the fluid distributor body comprises
a cylindrical boundary, forming a fluid inlet on an axial input side, and
a distributor structure disposed downstream of the fluid inlet for fluid distributing flow guidance of a fluid supplied via the fluid inlet,
wherein the distributor structure is provided by at least one perforated distributor plate made of an elastomer material and held on the boundary and having a plurality of passage openings conically tapering in flow direction.

9. The sanitary shower device according to claim 8, further comprising:
a shower connector body, including the shower inlet region, and
a shower main body, including the shower outlet region and being connected to the shower inlet body,
wherein the fluid distributor body is one of: disposed in the shower connector body adjacent to the shower main body; in the shower main body adjacent to the shower connector body; or interposed between the shower connector body and the shower main body.

10. The sanitary shower device according to claim 8, further comprising a flow restrictor disposed upstream ahead of the distributor body.

11. The fluid distributor body according to claim 1, wherein the distributor plate has a shape with an outwards curvature in flow direction towards a center of the plate.

12. The fluid distributor body according to claim 4, wherein the distributor plate has a shape with an outwards curvature in flow direction towards a center of the plate.

13. The fluid distributor body according to claim 1, wherein the fluid distributor body is configured as a sanitary fluid distributor body.

14. The sanitary shower device according to claim 9, further comprising a flow restrictor disposed upstream ahead of the distributor body.
